(19) United States
(12) Patent Application Publication
(10) Pub. No.: US 2025/0098583 A1
(43) Pub. Date: Mar. 27, 2025

(54) APPARATUS AND METHOD FOR MANAGING SETTINGS NOT ADJUSTED BY AUTOMATION

(71) Applicant: Deere & Company, Moline, IL (US)

(72) Inventors: Mario L. DONINI, Bettendorf, IA (US); Matthew T. WOLD, Coal Valley, IL (US); Jeremiah K. JOHNSON, Williamsburg, IA (US); Adam J. DONOHOE, West Branch, IA (US)

(73) Assignee: Deere & Company, Moline, IL (US)

(21) Appl. No.: 18/473,626

(22) Filed: Sep. 25, 2023

(51) Int. Cl. A01D 41/127; G05B 13/02

(52) U.S. Cl. CPC A01D 41/127; G05B 13/021

(57) ABSTRACT

A harvester includes a display and processing circuitry configured to cause the harvester to display, on the display, a plurality of selectable machine settings, receive an input from a user selecting or deselecting at least one particular machine setting of the plurality of machine settings, and automatically monitor and adjust a corresponding function of the harvester of only selected particular machine settings, of the plurality of selectable machine settings.

The present disclosure relates to agricultural machines, forestry machines, construction machines and turf management machines.

### BACKGROUND

There are a wide variety of different types of agricultural machines. Some agricultural machines include harvesters, such as combine harvesters, sugar cane harvesters, cotton harvesters, self-propelled forage harvesters, and windrowers. Some harvesters can also be fitted with different types of heads to harvest different types of crops.

### SUMMARY

Some example embodiments include a harvester including a plurality of selectable machine settings.

At least one example embodiment provides a harvester including a display and processing circuitry configured to cause the harvester to display, on the display, a plurality of selectable machine settings, receive an input from a user selecting or deselecting at least one particular machine setting of the plurality of machine settings, and automatically monitor and adjust a corresponding function of the harvester of only selected particular machine settings, of the plurality of selectable machine settings.

At least one example embodiment provides a method for controlling machine settings to be adjusted automatically by a harvester, the method including displaying, on a display, a plurality of selectable machine settings, receiving an input from a user selecting or deselecting at least one particular machine setting of the plurality of selectable machine settings, automatically monitoring and adjusting a corresponding function of the harvester of only selected particular machine settings of the plurality of selectable machine settings.

At least one example embodiment provides a non-transitory computer readable storage medium storing computer executable instructions that, when executed, cause a device to perform a method for controlling machine settings to be adjusted automatically by a harvester, the method including displaying, on a display a plurality of selectable machine settings, receiving an input from a user selecting or deselecting at least one particular machine setting of the plurality of selectable machine settings, and automatically monitoring and adjusting a corresponding function of the harvester of only selected particular machine settings, of the plurality of selectable machine settings.

At least one example embodiment provides a harvester including a means for displaying, on a display, a plurality of selectable machine settings, a means for receiving an input from a user selecting or deselecting at least one particular machine setting of the plurality of selectable machine settings, and a means for automatically monitoring and adjusting a corresponding function of the harvester of only selected particular machine settings of the plurality of selectable machine settings

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings.

FIG. 1 is a partial pictorial, partial schematic, illustration of a self-propelled agricultural harvester 100 according to example embodiments.

FIG. 2 is a block diagram showing some portions of an example agricultural harvester.

FIG. 3 is an example of a graphical user interface according to example embodiments

FIGS. 4 and 5 are examples of a graphical user interface according to example embodiments.

FIG. 5 is a flow chart of a method for performing calibration according to example embodiments.

FIG. 6 is a flow chart of a method for adjusting settings controlled by automation according to example embodiments.

In the drawings, reference numbers may be reused to identify similar and/or identical elements.

### DETAILED DESCRIPTION

In some example embodiments a harvester may be capable of automatically performing various functions (e.g., adjust settings of the harvester to perform a given function). For example, a harvester may be capable of automatically performing harvesting functions, terrain functions, cleaning functions, etc.

A user may enable the harvester to perform functions automatically. However, a user may want to perform some of the functions manually, while the harvester automatically performs others of the functions.

Example embodiments disclose a harvester including a user interface that allows a user to deselect some functions for automatic performance while maintaining automatic performance of other functions.

At least one example embodiment provides a harvester including a display and processing circuitry configured to cause the harvester to display, on the display, a plurality of selectable machine settings, receive an input from a user selecting or deselecting at least one particular machine setting of the plurality of machine settings, and automatically monitor and adjust a corresponding function of the harvester of only selected particular machine settings, of the plurality of selectable machine settings.

The processing circuitry may be further configured to cause the harvester to display the plurality of selectable machine settings divided into a plurality of categories.

The plurality of categories may include a plurality of subcategories.

The plurality of categories may include at least a harvest settings category and a terrain settings category.

The harvest settings category may include at least a threshing subcategory and a first cleaning subcategory, and the terrain settings category may include at least a second cleaning subcategory.

The threshing subcategory may include at least a threshing clearance selectable machine setting and a threshing speed selectable machine setting, the first cleaning subcategory may include at least a cleaning fan speed selectable machine setting, a first chaffer clearance selectable machine setting, and a first sieve clearance selectable machine setting, and the second cleaning subcategory may include at least a second chaffer clearance selectable machine setting and a second sieve clearance selectable machine setting.

The processing circuitry may be further configured to cause the harvester to initially display the plurality of selectable machine settings as being selected.

The processing circuitry may be further configured to cause the harvester to initially display the plurality of selectable machine settings (30) as being selected, receive a number of deselections of selectable machine settings of the plurality of selectable machine settings included in a particular subcategory of the plurality of subcategories, and disallow a deselection of remaining other machine settings of the particular subcategory in response to receiving the number of deselections.

The processing circuitry may be further configured to cause the harvester to receive a selection of a deselected machine setting of the number of deselected machine settings, and allow the deselection of the remaining other machine settings of the particular subcategory in response to the received selection.

The number of deselections may be one deselection.

The processing circuitry may be further configured to cause the harvester to allow the user to monitor and adjust functions of the harvester that the harvester is automatically monitoring and adjusting.

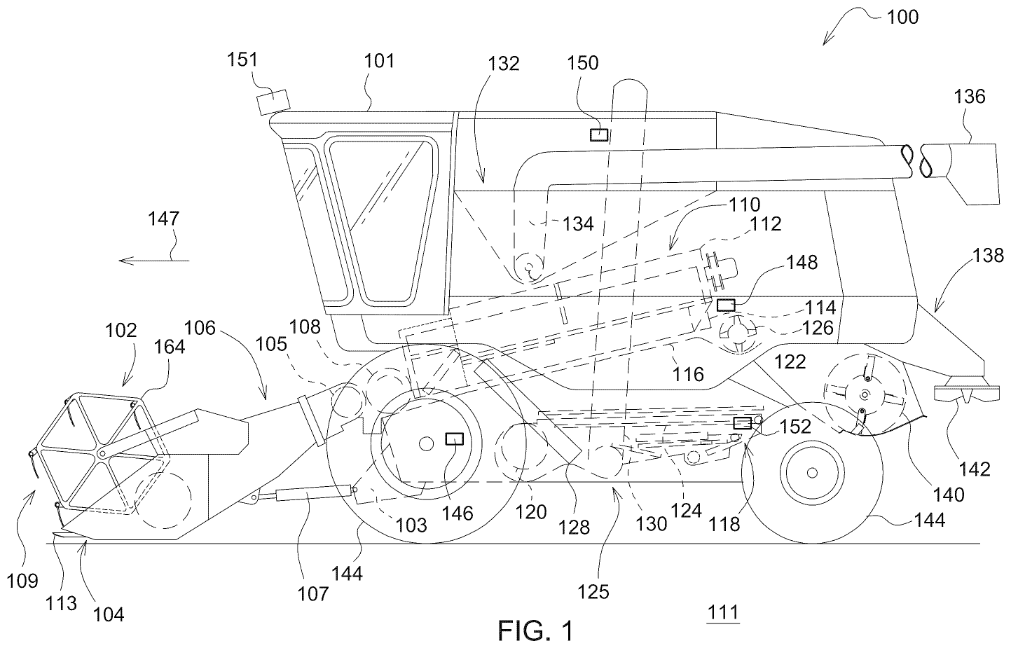

FIG. 1 is a partial pictorial, partial schematic, illustration of a self-propelled agricultural harvester 100 according to example embodiments. In the illustrated example, agricultural harvester 100 is a combine harvester. Further, although combine harvesters are provided as examples throughout the present disclosure, it will be appreciated that the present description is also applicable to other types of harvesters, such as cotton harvesters, sugarcane harvesters, self-propelled forage harvesters, windrowers, or other agricultural work machines. Consequently, the present disclosure is intended to encompass the various types of harvesters described and is, thus, not limited to combine harvesters. Moreover, the present disclosure is directed to other types of work machines, such as agricultural seeders and sprayers, construction equipment, forestry equipment, and turf management equipment where generation of a predictive map may be applicable. Consequently, the present disclosure is intended to encompass these various types of harvesters and other work machines and is, thus, not limited to combine harvesters.

As shown in FIG. 1, agricultural harvester 100 illustratively includes an operator compartment 101, which can have a variety of different operator interface mechanisms, for controlling agricultural harvester 100. Agricultural harvester 100 includes front-end equipment, such as a header 102, and a cutter generally indicated at 104. Agricultural harvester 100 also includes a feeder house 106, a feed accelerator 108, and a thresher generally indicated at 110. The feeder house 106 and the feed accelerator 108 form part of a material handling subsystem 125. Header 102 is pivotally coupled to a frame 103 of agricultural harvester 100 along pivot axis 105. One or more actuators 107 drive movement of header 102 about axis 105 in the direction generally indicated by arrow 109. Thus, a vertical position of header 102 (the header height) above ground 111 over which the header 102 travels is controllable by actuating actuator 107. While not shown in FIG. 1, agricultural harvester 100 may also include one or more actuators that operate to apply a tilt angle, a roll angle, or both to the header 102 or portions of header 102. Tilt refers to an angle at which the cutter 104 engages the crop. The tilt angle is increased, for example, by controlling header 102 to point a distal edge 113 of cutter 104 more toward the ground. The tilt angle is decreased by controlling header 102 to point the distal edge 113 of cutter 104 more away from the ground. The roll angle refers to the orientation of header 102 about the front-to-back longitudinal axis of agricultural harvester 100.

Thresher 110 illustratively includes a threshing rotor 112 and a set of concaves 114. Further, agricultural harvester 100 also includes a separator 116. Agricultural harvester 100 also includes a cleaning subsystem or cleaning shoe (collectively referred to as cleaning subsystem 118) that includes a cleaning fan 120, chaffer 122, and sieve 124. The material handling subsystem 125 also includes discharge beater 126, tailings elevator 128, clean grain elevator 130, as well as unloading auger 134 and spout 136. The clean grain elevator moves clean grain into clean grain tank 132. Agricultural harvester 100 also includes a residue subsystem 138 that can include chopper 140 and spreader 142. Agricultural harvester 100 also includes a propulsion subsystem that includes an engine that drives ground engaging components 144, such as wheels or tracks. In some examples, a combine harvester within the scope of the present disclosure may have more than one of any of the subsystems mentioned above. In some examples, agricultural harvester 100 may have left and right cleaning subsystems, separators, etc., which are not shown in FIG. 1.

In operation, and by way of overview, agricultural harvester 100 illustratively moves through a field in the direction indicated by arrow 147. As agricultural harvester 100 moves, header 102 (and the associated reel 164) engages the crop to be harvested and gathers the crop toward cutter 104. An operator of agricultural harvester 100 can be a local human operator, a remote human operator, or an automated system. As discussed in more detail later, a human operator may select or deselect certain operations for performance by the automated system.

The operator of agricultural harvester 100 may determine one or more of a height setting, a tilt angle setting, or a roll angle setting for header 102. For example, the operator inputs a setting or settings to a control system, described in more detail below, that controls actuator 107. The control system may also receive a setting from the operator for establishing the tilt angle and roll angle of the header 102 and implement the inputted settings by controlling associated actuators, not shown, that operate to change the tilt angle and roll angle of the header 102. The actuator 107 maintains header 102 at a height above ground 111 based on a height setting and, where applicable, at desired tilt and roll angles. Each of the height, roll, and tilt settings may be implemented independently of the others. The control system responds to header error (e.g., the difference between the height setting and measured height of header 104 above ground 111 and, in some examples, tilt angle and roll angle errors) with a responsiveness that is determined based on a selected sensitivity level. If the sensitivity level is set at a greater level of sensitivity, the control system responds to smaller header position errors, and attempts to reduce the detected errors more quickly than when the sensitivity is at a lower level of sensitivity.

Returning to the description of the operation of agricultural harvester 100, after crops are cut by cutter 104, the severed crop material is moved through a conveyor in feeder house 106 toward feed accelerator 108, which accelerates the crop material into thresher 110. The crop material is threshed by rotor 112 rotating the crop against concaves 114. The threshed crop material is moved by a separator rotor in separator 116 where a portion of the residue is moved by discharge beater 126 toward the residue subsystem 138. The portion of residue transferred to the residue subsystem 138 is chopped by residue chopper 140 and spread on the field by spreader 142. In other configurations, the residue is released from the agricultural harvester 100 in a windrow. In other examples, the residue subsystem 138 can include weed seed eliminators (not shown) such as seed baggers or other seed collectors, or seed crushers or other seed destroyers.

Grain falls to cleaning subsystem 118. Chaffer 122 separates some larger pieces of material from the grain, and sieve 124 separates some of finer pieces of material from the clean grain. Clean grain falls to an auger that moves the grain to an inlet end of clean grain elevator 130, and the clean grain elevator 130 moves the clean grain upwards, depositing the clean grain in clean grain tank 132. Residue is removed from the cleaning subsystem 118 by airflow generated by cleaning fan 120. Cleaning fan 120 directs air along an airflow path upwardly through the sieves and chaffers. The airflow carries residue rearwardly in agricultural harvester 100 toward the residue handling subsystem 138.

Tailings elevator 128 returns tailings to thresher 110 where the tailings are re-threshed. Alternatively, the tailings also may be passed to a separate re-threshing mechanism by a tailings elevator or another transport device where the tailings are re-threshed as well.

FIG. 1 also shows that, in one example, agricultural harvester 100 includes ground speed sensor 146, one or more separator loss sensors 148, a clean grain camera 150, a forward looking image capture mechanism 151, which may be in the form of a stereo or mono camera, and one or more loss sensors 152 provided in the cleaning subsystem 118.

Ground speed sensor 146 senses the travel speed of agricultural harvester 100 over the ground. Ground speed sensor 146 may sense the travel speed of the agricultural harvester 100 by sensing the speed of rotation of the ground engaging components (such as wheels or tracks), a drive shaft, an axel, or other components. In some instances, the travel speed may be sensed using a positioning system, such as a global positioning system (GPS), a dead reckoning system, a long range navigation (LORAN) system, or a wide variety of other systems or sensors that provide an indication of travel speed.

Loss sensors 152 illustratively provide an output signal indicative of the quantity of grain loss occurring in both the right and left sides of the cleaning subsystem 118. In some examples, sensors 152 are strike sensors which count grain strikes per unit of time or per unit of distance traveled to provide an indication of the grain loss occurring at the cleaning subsystem 118. The strike sensors for the right and left sides of the cleaning subsystem 118 may provide individual signals or a combined or aggregated signal. In some examples, sensors 152 may include a single sensor as opposed to separate sensors provided for each cleaning subsystem 118. Separator loss sensor 148 provides a signal indicative of grain loss in the left and right separators, not separately shown in FIG. 1. The separator loss sensors 148 may be associated with the left and right separators and may provide separate grain loss signals or a combined or aggregate signal. In some instances, sensing grain loss in the separators may also be performed using a wide variety of different types of sensors as well.

Agricultural harvester 100 may also include other sensors and measurement mechanisms. For instance, agricultural harvester 100 may include one or more of the following sensors: a header height sensor that senses a height of header 102 above ground 111; stability sensors that sense oscillation or bouncing motion (and amplitude) of agricultural harvester 100; a residue setting sensor that is configured to sense whether agricultural harvester 100 is configured to chop the residue, produce a windrow, etc.; a cleaning shoe fan speed sensor to sense the speed of fan 120; a concave clearance sensor that senses clearance between the rotor 112 and concaves 114; a threshing rotor speed sensor that senses a rotor speed of rotor 112; a chaffer clearance sensor that senses the size of openings in chaffer 122; a sieve clearance sensor that senses the size of openings in sieve 124; a material other than grain (MOG) moisture sensor that senses a moisture level of the MOG passing through agricultural harvester 100; one or more machine setting sensors configured to sense various configurable settings of agricultural harvester 100; a machine orientation sensor that senses the orientation of agricultural harvester 100; and crop property sensors that sense a variety of different types of crop properties, such as crop type, crop moisture, and other crop properties. Crop property sensors may also be configured to sense characteristics of the severed crop material as the crop material is being processed by agricultural harvester 100. For example, in some instances, the crop property sensors may sense grain quality such as broken grain, MOG levels; grain constituents such as starches and protein; and grain feed rate as the grain travels through the feeder house 106, clean grain elevator 130, or elsewhere in the agricultural harvester 100. The crop property sensors may also sense the feed rate of biomass through feeder house 106, through the separator 116 or elsewhere in agricultural harvester 100. The crop property sensors may also sense the feed rate as a mass flow rate of grain through elevator 130 or through other portions of the agricultural harvester 100 or provide other output signals indicative of other sensed variables.

Examples of sensors used to detect or sense the power characteristics include, but are not limited to, a voltage sensor, a current sensor, a torque sensor, a hydraulic pressure sensor, a hydraulic flow sensor, a force sensor, a bearing load sensor and a rotational sensor. Power characteristics can be measured at varying levels of granularity. For instance, power usage can be sensed machine-wide, subsystem-wide or by individual components of the subsystems.

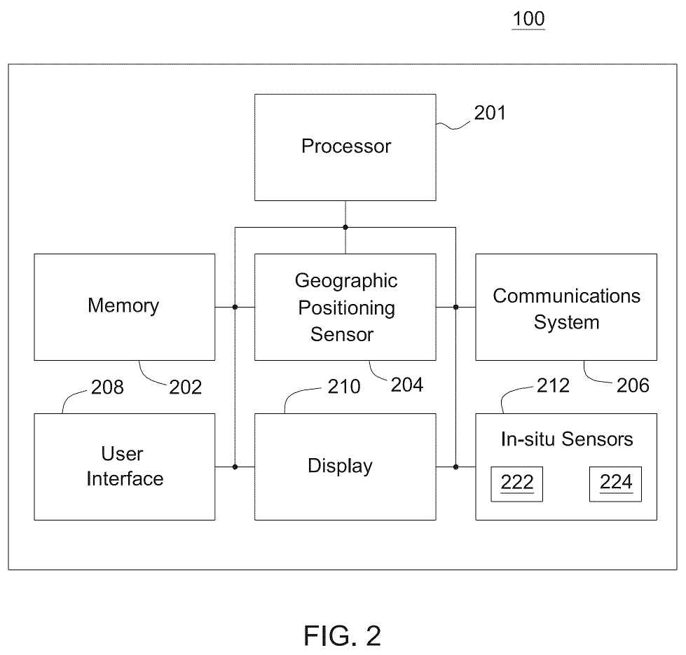

FIG. 2 is a block diagram showing some portions of an example agricultural harvester 100. FIG. 2 shows that agricultural harvester 100 illustratively includes processing circuitry (such as at least one processor 201), a memory 202, a geographic position sensor 204, a communication system 206, a user interface 208, a display 210, and/or one or more in-situ sensors 212 that sense one or more agricultural characteristics of a field concurrent with a harvesting operation. An agricultural characteristic can include any characteristic that can have an effect of the harvesting operation. Some examples of agricultural characteristics include characteristics of the harvesting machine, the field, the plants on the field, and the weather. Other types of agricultural characteristics are also included. The in-situ sensors 212 generate values corresponding to the sensed characteristics.

Geographic position sensor 204 illustratively senses or detects the geographic position or location of agricultural harvester 100. Geographic position sensor 204 can include, but is not limited to, a global navigation satellite system (GNSS) receiver that receives signals from a GNSS satellite transmitter. Geographic position sensor 204 can also include a real-time kinematic (RTK) component that is configured to enhance the precision of position data derived from the GNSS signal. Geographic position sensor 204 can include a dead reckoning system, a cellular triangulation system, or any of a variety of other geographic position sensors.

In-situ sensors 212 may be any of the sensors described above with respect to FIG. 1. In-situ sensors 212 may include on-board sensors 222 that are mounted on-board agricultural harvester 100. Such sensors may include, for instance, a perception sensor (e.g., a forward looking mono or stereo camera system and image processing system), image sensors that are internal to agricultural harvester 100 (such as the clean grain camera or cameras mounted to identify weed seeds that are exiting agricultural harvester 100 through the residue subsystem or from the cleaning subsystem). The in-situ sensors 212 may also include remote in-situ sensors 224 that capture in-situ information. In-situ data include data taken from a sensor on-board the harvester or taken by any sensor where the data are detected during the harvesting operation.

The memory 202 may include various special purpose program code including computer executable instructions which may cause the agricultural harvester 100 to perform the one or more of the methods of the example embodiments. The communication system 103 may include a wireless communication interface and/or a wired communication interface.

In at least one example embodiment, the processing circuitry may include at least one processor (and/or processor cores, distributed processors, networked processors, etc.), such as the at least one processor 201, which may be configured to control one or more elements of the agricultural harvester 100, and thereby cause the agricultural harvester 100 to perform various operations. The processing circuitry (e.g., the at least one processor 201, etc.) is configured to execute processes by retrieving program code (e.g., computer readable instructions) and data from the memory 202 to process them, thereby executing special purpose control and functions of the entire agricultural harvester 100. Once the special purpose program instructions are loaded into, (e.g., the at least one processor 201, etc.), the at least one processor 201 executes the special purpose program instructions, thereby transforming the at least one processor 201 into a special purpose processor.

In at least one example embodiment, the memory 202 may be a non-transitory computer-readable storage medium and may include a random access memory (RAM), a read only memory (ROM), and/or a permanent mass storage device such as a disk drive, or a solid state drive. Stored in the memory 202 is program code (i.e., computer readable instructions) related to operating the agricultural harvester 100.

A user may interact with the agricultural harvester 100 via the user interface 208. For example, the user interface may be one or more buttons and/or switches etc. Alternatively or additionally, the user interface may be a touch panel included in, for example, the display 210. The display 210 may be for example, an LCD display, an OLED display, etc. The user interface 208 and/or the display may be located in the operator compartment 101.

The agricultural harvester 100 may be able to perform various functions automatically. For example, the agricultural harvester 100 may be able automatically control various settings. For example, the agricultural harvester 100 may include an automation system configured to monitor and adjust the various settings.

The agricultural harvester 100 may be able to automatically control, for example: harvest settings including settings related to a threshing clearance settings related to a threshing speed, settings related to concave flaps, and/or settings related to separator flaps; terrain settings including settings related to a chaffer clearance and/or settings related to a sieve clearance; cleaning settings including settings related to a cleaning fan speed, settings related to a chaffer clearance, and/or settings related to a sieve clearance; grain header settings including settings related to a reel height, settings related to a reel speed, settings related to a header height, and/or header tilt; corn header settings including settings related to a deck plate spacing, settings related to an end divider position, settings related to a header height, and/or settings related to a header tilt; and/or residue settings including settings related to a spread spreader speed, settings related to a deflector position, and/or settings related to a knife bank position. However, the above are merely examples and the agricultural harvester 100 may be able to perform more or fewer functions automatically.

To increase customer utilization of automation technology (e.g., enhance human-machine teaming and trust in automation systems), according to example embodiments the user is given an experience to optionally remove one or more combine harvester machine settings from the total list of settings that are monitored and adjusted by the harvest automation system. The user is thereby opting in to a mixed task allocation situation, whereby the automation is systematically monitoring and adjusting some settings while the operator is manually monitoring or adjusting other settings.

The presentation of the settings selection and status of selection in a user interface (UI) according to example embodiments reinforces the customer mental model and mode awareness of the mixed task allocation.

The display 210 may be configured to display the user interface (UI), for example a graphic user interface (GUI) for operating the agricultural harvester 100.

FIG. 3 is an example of a graphical user interface according to example embodiments.

Referring to FIG. 3, a graphical user interface (GUI) 1 includes a plurality of categories 10. Each, or one or more, of the plurality of categories 10 includes a plurality of subcategories 20. Each, or one or more, of the plurality of subcategories 20 includes a plurality of settings 30. Each, or one or more, of the plurality of settings 30 has an associated indication indicating whether the setting 30 is selected. The example GUI 1 shown in FIG. 3 includes radio buttons 40 to indicate whether each setting 30 is selected. However, example embodiments are not limited thereto and any indication that a setting is selected may be used.

The categories 10 may correspond with automation system controls of the agricultural harvester 100. For example, the categories of automation system controls shown in FIG. 3 include harvest settings category and/or a terrain settings category. The harvest settings category may correspond with machine settings to keep grain loss and grain quality under user specified parameters. The terrain settings category may correspond with machine settings based on a pitch of the agricultural harvester 100.

FIG. 3 includes only two categories 10. However, example embodiments are not limited thereto and more categories 10 may be included.

Each, or one or more, of the categories 10 may include subcategories 20.

For example, as shown in FIG. 3, the category 10 harvest settings may include subcategories 20 threshing and cleaning.

Referring to FIG. 3, the category 10 terrain settings may include, for example, subcategory 20 cleaning.

It should be noted that the example shown in FIG. 3 includes one subcategory 20 of the category 10 terrain settings and two subcategories 20 of the category harvest settings. However, example embodiments are not limited thereto and a category 10 may include more than two categories.

For example, the harvest settings category 10 may additionally include further subcategories 20 including a header (e.g., grain header and/or corn header) subcategory 20 for controlling header height, deck plate spacing, backshaft speed, a residue subcategory 20 for controlling a knife bank position and/or a residue spread width, and/or a covers subcategory 20 for controlling separator grates to affect material distribution and loss and concave covers to affect threshing capabilities, etc.

Each, or one or more, of the subcategories 20 may include a plurality of settings 30. For example, as shown in FIG. 3, the threshing subcategory 20 includes a threshing clearance setting 30, and a threshing speed setting 30. The cleaning subcategory 20 of the harvest settings category 10 includes a cleaning fan speed setting 30, a chaffer clearance setting 30, and a sieve clearance setting 30. The cleaning subcategory 20 of the terrain settings category 10 includes a chaffer clearance setting 30 and a sieve clearance setting 30.

For example, when the chaffer setting 30 and/or the sieve clearance setting 30 is selected, the agricultural harvester 100 automatically controls variables related to a clearance, an opening, and/or a distance between rows of the chaffer and/or the sieve, respectively. When the threshing clearance setting 30 is selected, the agricultural harvester 100 automatically controls variables related to the clearance and/or distance between the concaves elements around the rotor and/or the threshing elements on the rotor. When the fan speed setting 30 is selected, the agricultural harvester 100 automatically controls variables related to the rotational speed of the fan turbines. For example, the agricultural harvester 100 may automatically control the selected settings to affect job outcomes (e.g., productivity, loss, grain quality, etc.).

However, example embodiments are not limited thereto and the subcategories 20 may include more or fewer settings 30.

For example, an additional grain header subcategory 20 may include settings 30 including reel height, reel speed, header height, and/or header tilt. An additional corn header subcategory 20 may include settings 30 including deck plate spacing, end divider position, header height, and/or header tilt. An additional residue automation subcategory 20 may include settings 30 including spreader speed, deflector position, and/or knife bank position.

Each of the settings 20 may be selected or deselected by a user. As shown in FIG. 3, each of the settings 30 has a corresponding radio button 40. However, example embodiments are not limited thereto, and any indication of selection/deselection may be used.

After a user has selected/deselected the desired settings 30, the user may press the save button 50 or the cancel button 60. The save button 50 sets the selected settings 30 to be monitored and adjusted by the automation system of the agricultural harvester 100. The cancel button 60 clears any changes made to selections/deselections of the settings 30 since the last time that the save button 50 was pressed.

In the example GUI 1 shown in FIG. 3, all of the radio buttons 40 are checked, indicating that all of the settings 30 are selected. Therefore, the agricultural harvester 100 is set to automatically perform adjustment of each of the settings 30 shown in the GUI 1 in FIG. 3.

Please note that, while the agricultural harvester 100 is set to adjust a setting 30, the user may still manually control the setting 30. For example, the user may not be locked out of controlling a setting when the agricultural harvester 100 is set to automatically control that setting.

A user may deselect a setting 30 (e.g., may uncheck a radio box 40 associated with a setting 30). If a setting is deselected, then the agricultural harvester 100 will not automatically control that setting once the save button 50 is pressed. According to some example embodiments, a user may select or deselect the settings 30 in any combination of selections.

The GUI 1 shown in FIG. 3 is an example of the GUI 1 presented to a user initially, according to some example embodiments. For example, a user may access the GUI 1 within a harvest automation preferences view. When the GUI 1 is initially displayed, all of the settings 30 may be selected. For example, the agricultural harvester 100 may select all of the settings 30 to be controlled automatically by default. A user may then deselect a given setting 30 via the GUI 1.

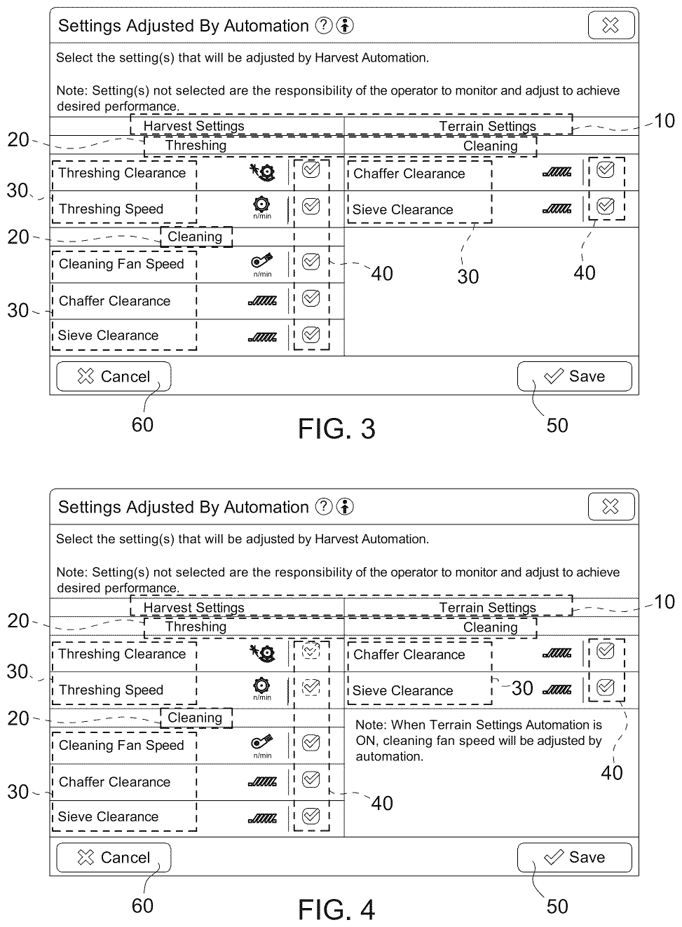

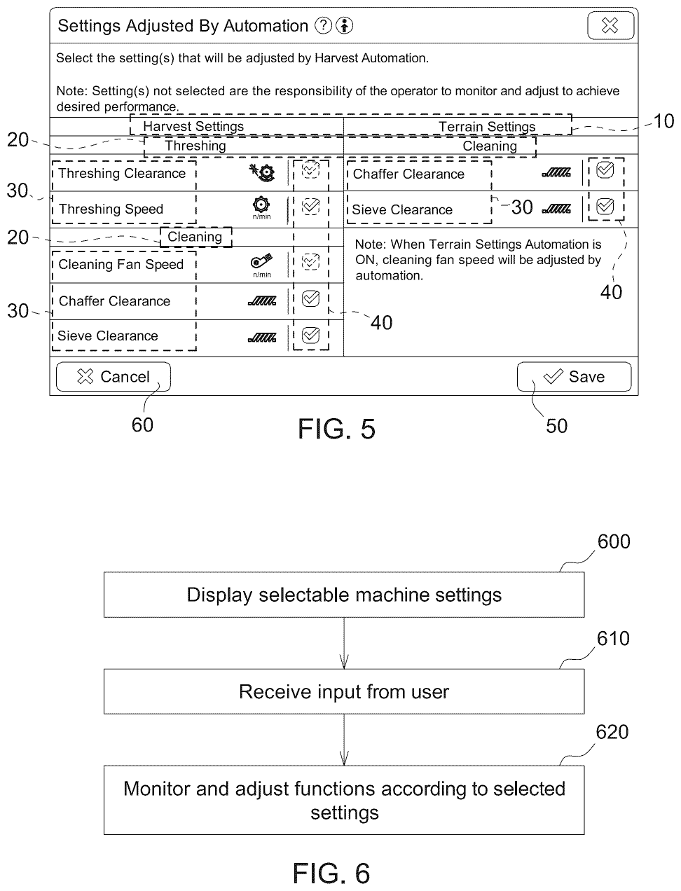

FIGS. 4 and 5 are examples of a graphical user interface according to example embodiments.

According to some example embodiments, a user may only deselect a particular number of settings 30 included in any one subcategory 20. For example, a user may only be able to deselect one setting 30 included in any one subcategory 20. However, example embodiments are not limited thereto, and a user may be allowed to deselect two or more (e.g., may be only allowed to deselect to, only allowed to deselect three, etc.) settings 30 included in any one subcategory 20.

FIG. 4 shows an example of the GUI 1 in a case where a user has deselected the threshing clearance setting 30 included in the threshing subcategory 20 of the harvest settings category 10.

Referring to FIG. 4, the radio button 40 associated with the threshing clearance setting 30 is deselected. Additionally, as shown in FIG. 4, the remaining settings 30 included in the subcategory 20 are greyed out so that a user is unable to deselect another setting 30 in the same subcategory 20. In the example shown in FIG. 4, the threshing speed setting 30 in the threshing subcategory 30 of the harvest settings category 10 is greyed out and cannot be deselected by the user.

The user could select the threshing clearance setting 30 to enable deselection of the threshing speed setting 30. For example, if the user selects the threshing clearance setting 30 in FIG. 4, the threshing subcategory 20 will be un-greyed and the GUI 1 will return to the view shown in FIG. 3.

FIG. 4 shows an example where remaining settings 30 in a subcategory 20 are greyed out and unable to be deselected when a user deselects one setting 30 of a subcategory 20. However, example embodiments are not limited thereto. For example, according to some example embodiments, a user may be able to deselect two settings 30 in any one subcategory 20. For example, the GUI 1 may grey out or otherwise prevent a user from deselecting a further setting 30 in a subcategory 20 when the user has deselected a second setting 30 in the subcategory 20. Further, according to some example embodiments, a user may be able to deselect three or more settings 30 in any one subcategory 20.

Referring to FIG. 5, the user may deselect a setting 30 in another subcategory 20. Specifically, FIG. 5 shows an example of a case where the user has deselected the threshing speed setting 30 as shown in FIG. 4 and additionally deselected the cleaning fan speed setting 30 in the cleaning subcategory 20 of the harvest settings category 10.

As shown in FIG. 5, the remaining settings included in the threshing subcategory 20 and the cleaning subcategory 20 of the harvest settings category 10 are greyed out so that the user cannot deselect any further settings 30 in either of those subcategories 20.

As shown in FIG. 5, the cleaning subcategory 20 of the terrain settings category 10 is not greyed out. The user may additionally deselect a setting 30 included in the cleaning subcategory 20 of the terrain settings 10.

Additionally, the user could select the cleaning fan speed setting 30 or the threshing clearance setting 30 to enable deselection of a different setting in the threshing subcategory 20 or the cleaning subcategory 20, respectively.

The mixed task allocation offered by the above described example embodiments may be part of a trust calibration process, whereby a user is trusting the automation system of the agricultural harvester 100 to adjust some settings, but not yet ready to relinquish manual control of the monitoring and adjusting for all settings.

For example, a user might choose to allow the system to monitor and adjust the threshing speed setting 30 of the threshing clearance subcategory 20 of the harvest settings category 10, and the chaffer clearance, cleaning fan speed, chaffer clearance, and sieve clearance settings 30 of the cleaning subcategory 20 of the harvest settings category 10, but choose to manually monitor and adjust the threshing clearance setting 30, as shown in FIG. 4. Performance of the automation system over time may better calibrate operator trust, and the operator may later give control of the threshing clearance setting 30 to the automation system.

For another example, in an example embodiment which allows a user to deselect up to two settings 30 per subcategory 20, a user might choose to manually control the cleaning fan speed setting 30 of the cleaning subcategory 20 of the harvest settings category 10. In this example, the cleaning subcategory 20 may allow deselection of a further setting 30 before the agricultural harvester 100 prevents the user from deselecting further settings 30 in the cleaning subcategory 20 (e.g., by greying out the cleaning subcategory 20). For example, the user may choose to additionally deselect the sieve clearance setting 30 in the cleaning subcategory 20 of the harvest settings category 10. Then, because the user has deselected the maximum number of settings 30 in the cleaning subcategory 20 (in this example, two settings 30), the agricultural harvester 100 will prevent the user from deselecting further settings 30 in the cleaning subcategory 20 (e.g., the chaffer clearance setting 30) until the user reselects as least one of the deselected settings 30 to bring the total number of deselected settings 30 in the cleaning subcategory 20 to be less than two.

Alternatively or additionally, the mixed task allocation offered by the above described example embodiments may be part of a system take-over, whereby a user feels they could do a better job at completing the task of monitoring and adjusting a setting 30 (for example, cleaning fan speed) than the automated system of the agricultural harvester 100. Whether the user is actually better than the automation system is irrelevant here, as the focus is on a successful experience for enabling better human-machine teaming and overall trust in the automation system through easy take-over and task assignment (e.g., clear to the user that they have taken over cleaning fan speed monitoring adjustment from the system).

FIG. 6 is a flow chart of a method for adjusting settings controlled by automation according to example embodiments.

For example purposes, the example embodiment shown in FIG. 6 will be discussed with regard to the system shown in FIG. 2. In at least this instance, it is understood that the processor 201 executing program code causes the agricultural harvester 100 to perform the method of FIG. 6. However, example embodiments should not be limited to this example.

Referring to FIG. 6, at S600 the agricultural harvester 100 displays a plurality of selectable machine settings 30. For example, the harvester 100 may display, on the display 210, the GUI 1. The GUI 1 may be displayed with the last saved selection of machine settings 30. For example, the GUI 1 may be displayed with default values of all of the settings 30 being selected, as shown in FIG. 3.

At S610, the agricultural harvester 100 receives an input from a user. For example, the user may select/deselect some of the settings 30, as described above and shown in FIGS. 4-6. The user may press the save button 50 to instruct the agricultural harvester 100 to perform automated control of the selected settings and to not perform automated control of the deselected settings.

At S620, the agricultural harvester 100 automatically monitors and adjusts the functions of the harvester according to the selected settings. For example, the agricultural harvester 100 may automatically monitors and adjust functions of the harvester corresponding to the settings 30 that are selected, and may not automatically monitor and adjust functions of the harvester corresponding to the settings 30 that are deselected.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. In the written description and claims, one or more steps within a method may be executed in a different order (or concurrently) without altering the principles of the present disclosure. Similarly, one or more instructions stored in a non-transitory computer-readable medium may be executed in different order (or concurrently) without altering the principles of the present disclosure. Unless indicated otherwise, numbering or other labeling of instructions or method steps is done for convenient reference, not to indicate a fixed order.

Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules) are described using various terms, including “connected,” “engaged,” “interfaced,” and “coupled.” Unless explicitly described as being “direct,” when a relationship between first and second elements is described in the above disclosure, that relationship encompasses a direct relationship where no other intervening elements are present between the first and second elements, and also an indirect relationship where one or more intervening elements are present (either spatially or functionally) between the first and second elements.

The phrase “at least one of A, B, and C” should be construed to mean a logical (A OR B OR C), using a non-exclusive logical OR, and should not be construed to mean “at least one of A, at least one of B, and at least one of C.” The term “set” does not necessarily exclude the empty set. The term “non-empty set” may be used to indicate exclusion of the empty set. The term “subset” does not necessarily require a proper subset. In other words, a first subset of a first set may be coextensive with (equal to) the first set.

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

One or more of the elements disclosed above may include or be implemented in one or more processing circuitries such as hardware including logic circuits; a hardware/software combination such as a processor executing software; or a combination thereof. For example, the processing circuitries more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc.

In this application, including the definitions below, the term “module” or the term “controller” may be replaced with the term “circuit.” The term “module” may refer to, be part of, or include processor hardware (shared, dedicated, or group) that executes code and memory hardware (shared, dedicated, or group) that stores code executed by the processor hardware.

The module may include one or more interface circuits. In some examples, the interface circuit(s) may implement wired or wireless interfaces that connect to a local area network (LAN) or a wireless personal area network (WPAN). Examples of a LAN are Institute of Electrical and Electronics Engineers (IEEE) Standard 802.11-2016 (also known as the WIFI wireless networking standard) and IEEE Standard 802.3-2015 (also known as the ETHERNET wired networking standard). Examples of a WPAN are IEEE Standard 802.15.4 (including the ZIGBEE standard from the ZigBee Alliance) and, from the Bluetooth Special Interest Group (SIG), the BLUETOOTH wireless networking standard (including Core Specification versions 3.0, 4.0, 4.1, 4.2, 5.0, and 5.1 from the Bluetooth SIG).

The module may communicate with other modules using the interface circuit(s). Although the module may be depicted in the present disclosure as logically communicating directly with other modules, in various implementations the module may actually communicate via a communications system. The communications system includes physical and/or virtual networking equipment such as hubs, switches, routers, and gateways. In some implementations, the communications system connects to or traverses a wide area network (WAN) such as the Internet. For example, the communications system may include multiple LANs connected to each other over the Internet or point-to-point leased lines using technologies including Multiprotocol Label Switching (MPLS) and virtual private networks (VPNs).

In various implementations, the functionality of the module may be distributed among multiple modules that are connected via the communications system. For example, multiple modules may implement the same functionality distributed by a load balancing system. In a further example, the functionality of the module may be split between a server (also known as remote, or cloud) module and a client (or, user) module. For example, the client module may include a native or web application executing on a client device and in network communication with the server module.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave); the term computer-readable medium is therefore considered tangible and non-transitory. Non-limiting examples of a non-transitory computer-readable medium are nonvolatile memory devices (such as a flash memory device, an erasable programmable read-only memory device, or a mask read-only memory device), volatile memory devices (such as a static random access memory device or a dynamic random access memory device), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. Such apparatuses and methods may be described as computerized apparatuses and computerized methods. The functional blocks and flowchart elements described above serve as software specifications, which can be translated into the computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, JavaScript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

1. A harvester comprising:
a display; and
processing circuitry configured to cause the harvester to,
display, on the display, a plurality of selectable machine settings,
receive an input from a user selecting or deselecting at least one particular machine setting of the plurality of selectable machine settings, and
automatically monitor and adjust a corresponding function of the harvester of only selected particular machine settings of the plurality of selectable machine settings.

2. The harvester of claim 1, wherein the processing circuitry is further configured to cause the harvester to display the plurality of selectable machine settings divided into a plurality of categories.

3. The harvester of claim 2, wherein the plurality of categories includes a plurality of subcategories.

4. The harvester of claim 2, wherein the plurality of categories includes at least a harvest settings category and a terrain settings category.

5. The harvester of claim 4, wherein the harvest settings category includes at least a threshing subcategory and a first cleaning subcategory, and the terrain settings category includes at least a second cleaning subcategory.

6. The harvester of claim 5, wherein:
the threshing subcategory includes at least a threshing clearance selectable machine setting and a threshing speed selectable machine setting;
the first cleaning subcategory includes at least a cleaning fan speed selectable machine setting, a first chaffer clearance selectable machine setting, and a first sieve clearance selectable machine setting; and
the second cleaning subcategory includes at least a second chaffer clearance selectable machine setting and a second sieve clearance selectable machine setting.

7. The harvester of claim 1, wherein the processing circuitry is further configured to cause the harvester to initially display the plurality of selectable machine settings as being selected.

8. The harvester of claim 3, wherein the processing circuitry is further configured to cause the harvester to:
initially display the plurality of selectable machine settings as being selected;
receive a number of deselections of selectable machine settings of the plurality of selectable machine settings included in a particular subcategory of the plurality of subcategories; and
disallow a deselection of remaining other machine settings of the particular subcategory in response to receiving the number of deselections.

9. The harvester of claim 8, wherein the processing circuitry is further configured to cause the harvester to:
receive a selection of a deselected machine setting of the number of deselected machine settings; and
allow the deselection of the remaining other machine settings of the particular subcategory in response to the received selection.

10. The harvester of claim 8, wherein the number of deselections is one deselection.

11. The harvester of claim 1, wherein the processing circuitry is further configured to cause the harvester to:
allow the user to monitor and adjust functions of the harvester that the harvester is automatically monitoring and adjusting.

12. A method for controlling machine settings to be adjusted automatically by a harvester, the method comprising:
displaying, on a display a plurality of selectable machine settings;
receiving an input from a user selecting or deselecting at least one particular machine setting of the plurality of selectable machine settings; and
automatically monitoring and adjusting a corresponding function of the harvester of only selected particular machine settings of the plurality of selectable machine settings.

13. The method of claim 12, wherein the displaying includes displaying the plurality of selectable machine settings divided into a plurality of categories.

14. The method of claim 13, wherein the plurality of categories includes a plurality of subcategories.

15. The method of claim 12, wherein the displaying includes initially displaying the plurality of selectable machine settings as being selected.

16. The method of claim 14, wherein:
the displaying includes initially displaying the plurality of selectable machine settings as being selected;
the receiving includes receiving a number of deselections of a selectable machine settings of the plurality of selectable machine settings included in a particular subcategory of the plurality of subcategories; and
the method further includes disallowing a deselection of remaining other machine settings of the particular subcategory in response to receiving the number of deselections.

17. The method of claim 16, further comprising:
receiving a selection of a deselected machine setting of the number of deselected machine settings; and
allowing the deselection of the remaining other machine settings of the particular subcategory in response to the received selection.

18. The method of claim 16, wherein the number of deselections is one deselection.

19. A non-transitory computer readable storage medium storing computer executable instructions that, when executed, cause a device to perform a method for controlling machine settings to be adjusted automatically by a harvester, the method comprising:
displaying, on a display a plurality of selectable machine settings;
receiving an input from a user selecting or deselecting at least one particular machine setting of the plurality of selectable machine settings; and
automatically monitoring and adjusting a corresponding function of the harvester of only selected particular machine settings of the plurality of selectable machine settings.

20. The non-transitory computer readable storage medium of claim 19, wherein the displaying includes displaying the plurality of selectable machine settings divided into a plurality of categories and the plurality of categories is divided into a plurality of subcategories.
